(19) United States
(12) Patent Application Publication
(10) Pub. No.: US 2002/0101530 A1
(43) Pub. Date: Aug. 1, 2002

(54) Camera system and method for operating same

(75) Inventor: Daniel Pelletier, Lake Peekskill, NY (US)

Correspondence Address: Corporate Patent Counsel, U.S. Philips Corporation, 580 White Plains Road, Tarrytown, NY, 10591, US

(73) Assignee: Philips Electronics North America Corporation

(21) Appl. No.: 09/772,484

(22) Filed: Jan. 29, 2001

(51) Int. Cl. H04N 5/225; H04N 5/228

(52) U.S. Cl. 348/333.02; 348/222; 348/207

(57) ABSTRACT

A camera system and method for operating same. In one embodiment, the method comprises the steps of providing a camera system comprising a camera and a central processing unit, capturing a view of a subject with the camera, determining cinematographic parameters of the view, comparing the determined cinematographic parameters to reference cinematographic parameters, formulating recommended camera operation based on the comparison of the determined cinematographic parameters to the reference cinematographic parameters, and indicating the recommended camera operation to the user.

### BACKGROUND OF THE INVENTION

1. Field Of The Invention

The present invention generally relates to a camera system and a method that provides information to the user concerning recommended camera operation that improves the quality of the view captured by the camera system.

2. Description of Related Art

Conventional camera systems are capable of determining the quality of the composition of a view captured by the camera by performing image processing analysis on the captured view. Such a system is described in U.S. Pat. No. 5,831,670.

### SUMMARY OF THE INVENTION

The camera system of the present invention utilizes computer vision to analyze a video sequence and make recommendations to a camera operator as to the best way to move the camera 14 (e.g. direction to pan, tilt, zoom, etc.). The recommendations are based on many factors, such as simple principles of good video practice (e.g. not maintaining a static view of a subject for an extended period of time), accepted principles of quality cinematography and image analysis. Specifically, the camera system of the present invention analyzes the video and the current view or shot that is being captured by the camera, determines the cinematographic parameters of the captured view, compares the cinematographic parameters to the reference cinematographic parameters, and generates recommended camera operation that will improve the overall quality of the view or inform the user as to the next view that should be captured by the camera.

In one aspect, the present invention is directed to a method of operating a camera system comprising the steps of providing a camera system comprising a camera and a central processing unit, capturing a view of a subject with the camera, determining cinematographic parameters of the captured view, comparing the determined cinematographic parameters to reference cinematographic parameters, formulating recommended camera operation based on the comparison of the determined cinematographic parameters to the reference cinematographic parameters, and indicating the recommended camera operation to the user.

In another aspect, the present invention is directed to a camera system comprising a central processing unit and a camera for capturing a view of a subject. The central processor is in data communication with the camera. The central processor is configured to (1) determine the cinematographic parameters of the view, (ii) compare the determined cinematographic parameters to predetermined cinematographic parameters, and (iii) formulate recommended camera operation based on the comparison of the determined cinematographic parameters to the reference cinematographic parameters. In one embodiment, the camera system further includes an indicating device for indicating the recommended camera operation to the user.

In a further aspect, the present invention is directed to an article of manufacture, comprising a computer processor usable medium having computer processor readable program code embodied therein for determining the cinematographic parameters of a view captured by a camera and formulating recommended camera operation to improve the quality of the view using a camera system comprising a central processing unit and a camera for capturing a view of a subject. The central processor unit is in data communication with the camera. The central processor is configured to (i) determine the cinematographic parameters of the view, (ii) compare the determined cinematographic parameters to reference cinematographic parameters, and (iii) formulate recommended camera operation based on the comparison of the determined cinematographic parameters to the reference cinematographic parameters. The computer processor readable program code in the article of manufacture comprises:

computer processor readable program code configured to cause the camera system to determine the cinematographic parameters of a view captured by the camera;

computer processor readable program code configured to cause the camera system to compare the determined cinematographic parameters to reference cinematographic parameters;

computer processor readable program code configured to cause the camera system to formulate recommended camera operation based on the comparison of the determined cinematographic parameters to the reference cinematographic parameters; and

computer processor readable program code configured to cause the camera system to indicate the recommended camera operation to the user.

### BRIEF DESCRIPTION OF THE DRAWINGS

The features of the invention are believed to be novel and the elements characteristic of the invention are set forth with particularity in the appended claims. The invention itself, both as to organization and method of operation, may best be understood by reference to the detailed description which follows taken in conjunction with the accompanying drawings in which:

FIG. 1 is a block diagram of one embodiment of the camera system of the present invention.

FIG. 2 is a flow sheet of the method of the present invention.

### DETAILED DESCRIPTION OF THE INVENTION

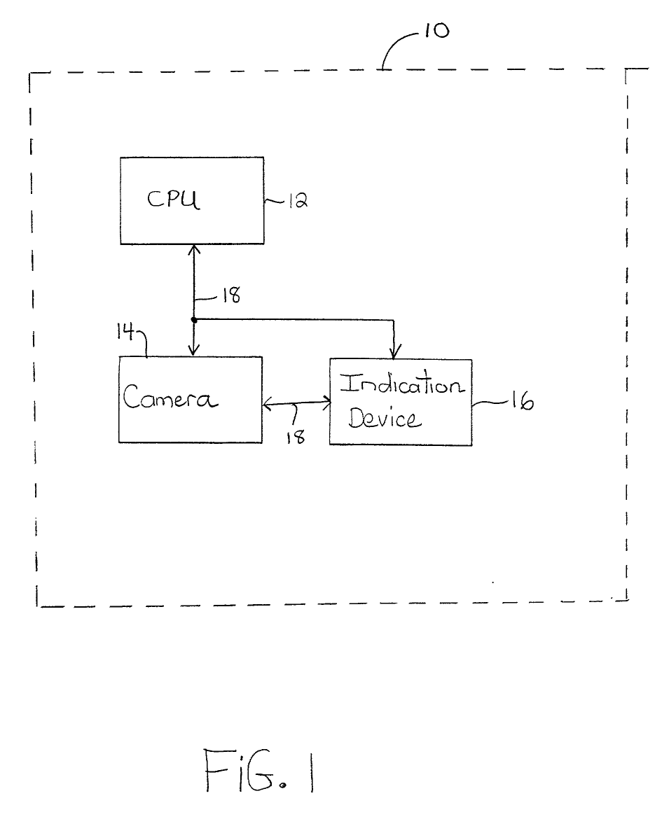

Referring to FIG. 1, camera system 10 of the present invention generally comprises central processing unit (“CPU”) 12, camera 14. In one embodiment, camera system 10 further comprises indication device 16. CPU 12 generally comprises a micro-computer and peripheral devices that control the operation of camera 14. In a preferred embodiment, camera system 10 is configured as a computer vision system that is well known in the art. CPU 12 is in electronic data communication with camera 14 and indicator device 16 via link 18. Link 18 also effects electronic data communication between camera 14 and indicator device 16. In one embodiment, link 18 is realized by dedicated data lines. However, it is to be understood that data communication link 18 can be realized as an Internet connection using a publicly switched phone network, cellular, personal communication (“PCS”), microwave or satellite network. In a preferred embodiment, CPU 12 includes a user interface that enables data to be inputted into the microprocessor of CPU 12.

Camera 14 comprises a body having a portion configured for handling by a user.

Camera 14 can be configured to use electronic-pan-tilt-zoom (“EPTZ”) or automatic mechanical-pan-tilt-zoom (“MPTZ”). Camera 14 further includes an interface circuit (not shown) that enables transfer of data between camera 14 and CPU 12 and as well as between camera 14 and indication device 16. Camera 14 generates video data that defines the captured view. The video data is inputted into CPU 12.

Indicator device 16 is configured to provide a function for displaying photographic information such as photographic recommendations, e.g. “capture close-up view”, “capture wide-angle view”, “fade out”, etc. In one embodiment, indicator device 16 comprises circuitry and components to provide a warning function such as a buzzer, a synthesizer sound, a vibration or the like. In one embodiment, indicator device 16 comprises a liquid crystal display. In one embodiment, indicator device 16 is configured as the indicator device described in U.S. Pat. No. 5,831,670, the disclosure of which is incorporated herein by reference.

CPU 12 is programmed with the appropriate algorithm to effect determination of the cinematographic parameters of the shot or view defined by the video data received from camera 14. Such cinematographic parameters include, but are not limited to the:

a) angle of the captured view or shot of the subject;

b) duration of time that camera 14 remains fixed on the subject;

c) number of subjects in the view;

d) distance between camera 14 and the subject or subjects;

e) amount of activity in the scene;

f) primary subject of interest within the captured view or shot; and

g) overall quality of the captured view.

Prior to the operation of camera system 10, reference data is inputted into the microprocessor of CPU 12. The reference data defines reference or predetermined cinematographic parameters based upon sound principles of cinematography. In preferred embodiment, the reference data may be inputted into the microprocessor of CPU 12 via the user interface of CPU 12. The aforementioned algorithm enables CPU 12 to effect a comparison between the determined cinematographic parameters of the view and the reference cinematographic parameters.

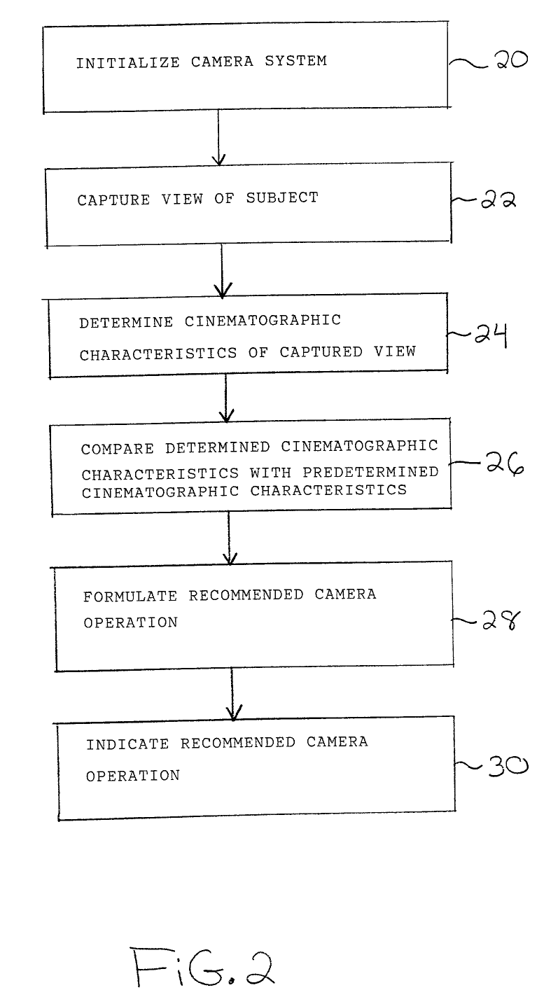

Each step of the method of the present invention is described in the ensuing description with reference being made to FIGS. 1 and 2.

The first step 20 of the method of the present invention comprises initializing camera system 10. This step entails inputting the reference cinematographic parameters into CPU 12 and verifying correct data communications with camera 14 and indicator device 16. During this step, camera 14 is controlled so as to capture its first view or shot of a particular subject.

In step 22, camera 14 generates video data defining the captured view. Such video data is transmitted over link 18 to CPU 12.

Step 24 effects determination of the cinematographic parameters of the view captured by camera 14.

In step 26, CPU 12 effects a comparison of the determined cinematographic parameters and the reference cinematographic parameters. This step also determines the level of quality of the view. In a preferred embodiment, this step determines whether the cinematographic parameters of the current view cause the overall quality of that particular view to be above or below a predetermined level of quality. The predetermined level of quality is based upon the aforementioned reference cinematographic parameters inputted into CPU 12.

In step 28, CPU 12 generates or formulates data that defines recommended camera operation that will address particular deficiencies determined by the comparison step 26 and to improve the overall quality of the shot or view. The data defining the recommended camera operation is transmitted to camera 14 and indicating device 16.

In step 30, the recommended camera operation is indicated to the users of camera 14 and, unless overridden by the user of camera 14, is implemented by the users of camera 14 or automatically by camera 14. The manner in which the recommended camera operation is implemented depends upon the configuration of camera 14. For example, if camera 14 is configured as an EPTZ camera and the recommended camera operation defines a new or next view that should be captured, that particular new or next view appears in the view finder of camera 14. The user of camera 14 need only activate the appropriate control on camera 14 to cut to the next view at which point, camera 14 implements EPTZ to take the next (i.e. the recommended) view. If camera 14 is configured as an MPTZ camera, then the data defining the recommended camera operation is converted into control signals that are used to control the motors of camera 14. As a result, the motors position camera 14 so as to facilitate capture of the recommended view or shot. The recommended camera operation is displayed on indicating device 16. Thus, recommended camera operation such as “close-up”, or “fade-out”, etc. can appear on indicating device 16 thereby providing the user with an indication of the recommended camera operation and the opportunity to manually override the recommended camera operation. If camera 14 is neither an EPTZ camera nor an MPTZ camera, then the user manually operates the controls of camera 14 in accordance with the recommended camera operation.

In another embodiment, sensors (not shown) can be used in conjunction with camera 14 to provide other types of information that can be used to determine the recommended camera operation. Specifically, the output of these sensors would be inputted into CPU 12 as part of the determined cinematographic parameters and used in the comparison step 26 that was described in the foregoing description. Such sensors include audio sensors and motion sensors. In one example, the sensor is an audio sensor and is configured to detect the part of the set from which audio information is emanating. Thus, if the current shot or view is of a character who has just stopped speaking, and another character that is not in the view begins speaking, then the audio sensor outputs signals that indicate that sounds are emanating from a particular location of the set that is not in the current view. The audio sensor output signals are inputted into CPU 12. In response, CPU 12 outputs data defining recommended camera operation that will enable camera 14 to capture the view of the new speaker.

The present invention can be embodied in the form of computer processor readable program code embodied in a computer processor usable medium, such as floppy diskettes, CD-ROMs, hard drives, or any other computer-readable storage medium, wherein, when the computer program code is loaded into and executed by a computer, the computer becomes an integral part of an apparatus or system for practicing the invention.

The principals, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations in changes may be made by those skilled in the art without departing from the spirit of the invention. Accordingly, the foregoing detailed description should be considered exemplary in nature and not limited to the scope and spirit of the invention as set forth in the attached claims.

Thus, having described the invention, what is claimed is:

1. A method of operating a camera system comprising the steps of:
providing a camera system comprising a camera and a central processing unit;
capturing a view of a subject with the camera;
determining the cinematographic parameters of the view;
comparing the determined cinematographic parameters to reference cinematographic parameters;
formulating recommended camera operation based on the comparison of the determined cinematographic parameters to the reference cinematographic parameters; and
indicating the recommended camera operation to the user.

2. The method according to claim 1 further comprising the step of effecting camera operation in accordance with the recommended camera action.

3. The method according to claim 1 wherein the providing step further comprises the step of inputting data defining the reference cinematographic parameters into the central processor.

4. The method according to claim 1 wherein the capturing step comprises the step of generating video data defining the view.

5. The method according to claim 4 further comprising the step of analyzing the video data and comparing it to the reference cinematographic parameters.

6. The method according to claim 1 wherein the determining step includes the step of measuring the length of time during which the view remains the same.

7. The method according to claim 1 wherein the comparing step comprises the step of determining the level of quality of the view based on the comparison between the determined cinematographic parameters and the reference cinematographic parameters.

8. The method according to claim 7 further comprising the step of formulating recommended camera operation that effects capture of a new view if it is determined that the quality of the captured view is below a predetermined level of quality.

9. The method according to claim 1 further comprising the step of comparing the determined length of time to a predetermined length of time.

10. The method according to claim 9 further comprising the step of formulating recommended camera operation so as to capture a new view if the determined length of time exceeds the predetermined length of time.

11. The method according to claim 1 wherein the captured view has an angle and the determined step comprises the step of determining the angle of the view.

12. The method according to claim 1 wherein the comparing step comprises comparing the determined angle of the captured view to a reference angle defined by the reference cinematographic parameters.

13. The method according to claim 11 wherein the formulating step comprises the step of formulating recommended camera operation that effects variation of the angle of the captured view.

14. A camera system, comprising:
a camera system comprising a central processing unit and a camera for capturing a view of a subject, the central processor unit being in data communication with the camera, the central processor being configured to (i) determine the cinematographic parameters of the captured view, (ii) compare the determined cinematographic parameters to reference cinematographic parameters, and (iii) formulate recommended camera operation based on the comparison of the determined cinematographic parameters to reference cinematographic parameters; and
an indicating device for indicating the recommended camera operation to the user.

15. The camera system according to claim 14 further comprising means for controlling the camera in accordance with the formulated recommended camera action.

16. An article of manufacture, comprising a computer processor usable medium having computer processor readable program code embodied therein for determining the cinematographic parameters of a view captured by a camera and formulating recommended camera operation using a camera system comprising a central processing unit and a camera for capturing a view of a subject, the central processor unit being in data communication with the camera, the central processor being configured to (i) determine the cinematic parameters of the view, (ii) compare the determined cinematic parameters to reference cinematographic parameters, and (iii) formulate recommended camera operation based on the comparison of the determined cinematographic parameters to reference cinematographic parameters, the computer processor readable program code in the article of manufacture comprising:
computer processor readable program code configured to cause the camera system to determine the cinematographic parameters of a view captured by the camera;
computer processor readable program code configured to cause the camera system to compare the determined cinematographic parameters to reference cinematographic parameters;
computer processor readable program code configured to cause the camera system to formulate recommended camera operation based on the comparison of the determined cinematographic parameters and reference cinematographic parameters; and
computer processor readable program code configured to cause the camera system to indicate the recommended camera operation to the user.
